(19) United States
(12) Patent Application Publication
(10) Pub. No.: US 2012/0324247 A1
(43) Pub. Date: Dec. 20, 2012

(54) POWER SUPPLY CIRCUIT FOR CPU

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 13/195,863

(22) Filed: Aug. 2, 2011

(30) Foreign Application Priority Data
Jun. 15, 2011 (CN) 201110159806.1

(51) Int. Cl. G06F 1/26

(52) U.S. Cl. 713/300

(57) ABSTRACT

An exemplary power supply circuit includes a voltage adjustment module electrically coupled to a CPU, a first jumper block, a second jumper block, a first jumper, and a second jumper. The first jumper block includes a first pin electrically coupled to a power source, a second pin electrically coupled to the voltage adjustment module, and a third pin grounded. The first (second) jumper electrically connects the first pin of the first (second) jumper block to the second pin of the first (second) jumper block or electrically connects the second pin of the first (second) jumper block to the third pin of the first (second) jumper block, thereby changing signal output by the second pin of the first (second) jumper. The voltage adjustment module adjusts a phase number power supply to supply corresponding phase power to the CPU based on the voltages output by the second pins.

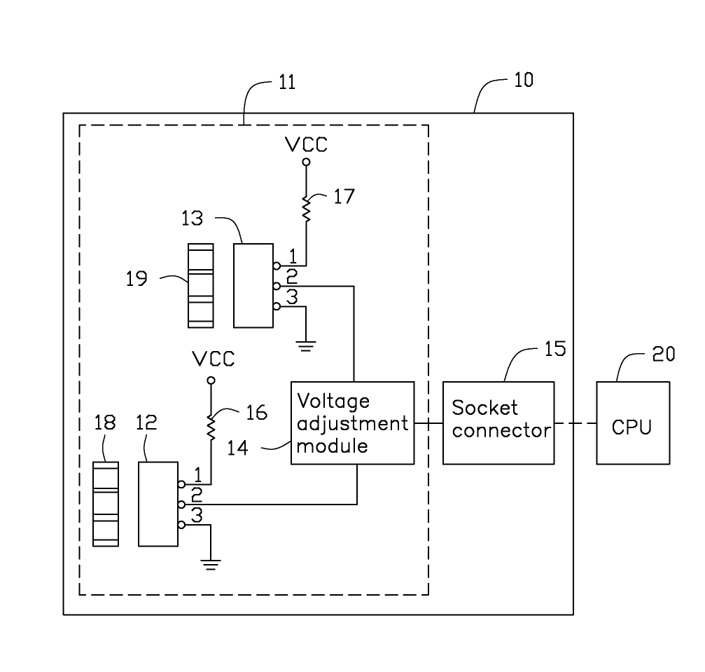

### 1. TECHNICAL FIELD

The present disclosure relates to power supply circuits and, particularly, to a power supply circuit for providing power to a central processing unit (CPU).

### 2. DESCRIPTION OF RELATED ART

Some computers have two or more CPUs to improve the information processing ability of the computers. When the CPU is working at a maximum power, the maximum power may be 130 W.

However, in a dual-processor system, when one CPU with a maximum working power is in an idle state, and a second CPU with a less working power is working, the second CPU may only need 100 W or less to function. In such a case, much power is wasted in the power supply circuit of the CPU.

Therefore, what is needed is a new power supply circuit for a CPU that can overcome the described limitations.

### BRIEF DESCRIPTION OF THE DRAWINGS

The drawing is an isometric view of a power supply circuit for a CPU according to an exemplary embodiment.

### DETAILED DESCRIPTION

Embodiments will now be described in detail with reference to the drawing.

Referring to the drawing, a power supply circuit 100, in accordance with an exemplary embodiment, is arranged on a motherboard 10. The power supply circuit 100 supplies power to a CPU 20 on the motherboard 10. The motherboard 10 also includes a socket connector 15 for electrically connecting the CPU 20 to the motherboard 20.

The power supply circuit 11 includes a first jumper block 12, a second jumper block 13, a voltage adjustment module 14, a first jumper 18, and a second jumper 19. The voltage adjustment module 14 is electrically coupled to the socket connector 15 for supplying power to the CPU via the socket connector 15.

Structure of the first jumper block 12 is similar to that of the second jumper block 12. Each of the first jumper block 12 and the second jumper block 13 includes a first pin 1, a second pin 2, and a third pin 3. The first pins 1 of the first jumper block 12 and the second jumper block 13 are electrically coupled to two power sources VCC via two pull up resistors 16 and 17, respectively. The second pins 2 of the first jumper block 12 and the second jumper block 13 are electrically coupled to two enable ends (not labeled) of the voltage adjustment module 14, respectively. The third pins 3 of the first jumper block 12 and the second jumper block 13 are grounded.

In a default state, the first pin 1 of the first jumper block 12 is electrically coupled to the second pin 2 of the first jumper block 12 via the first jumper 18, and the first pin 1 of the second jumper block 13 is electrically coupled to the second pin 2 of the second jumper block 13 via the second jumper 19.

In the embodiment, a high logic signal “1” (high level voltage) is 5V, and a low logic signal “0” (low level voltage) is 0V. Because the first pins 1 of the first jumper block 12 and the second jumper block 13 are electrically coupled to two power sources VCC via pull up resistors 16 and 17, respectively, the second pins 2 of the first jumper block 12 and the second jumper block 13 are set at a high level voltage. In such a case, the voltage adjustment module 14 will supply full phase power to the CPU 20. Accordingly, the CPU 20 with a maximum power can be powered. The pull up resistors 16 and 17 keep the second pins 2 of the first jumper block 12 and the second jumper block 13 at high level voltages in the default state, respectively.

When the CPU 20 with a different working power is arranged on the motherboard 10, the second pin 2 of the first jumper block 12 is electrically coupled to the first pin 1 or the third pin 3 of the first jumper block 12 via the first jumper 18, and/or the second pin 2 of the second jumper block 13 is electrically coupled to the first pin 1 or the third pin 3 of the second jumper block 13 via the second jumper 19. Accordingly, the voltage adjustment module 14 can supply corresponding phase number power supplies to the corresponding CPU 20.

In one exemplary embodiment, when a difference value between the maximum power output by the voltage adjustment module 14 and the working power of the used CPU 20 is greater than 60 W, the second pin 2 of the first jumper block 12 is electrically coupled to the third pin 3 of the first jumper block 12 via the first jumper 18, and the second pin 2 of the second jumper block 12 is electrically coupled to the third pin 3 of the second jumper block 13 via the first jumper 19. In such a case, the second pins 2 of the first jumper block 12 and the second jumper block 13 are set at low level voltages. When the voltage adjustment module 14 receives a low level voltage output by the second pins 2, the voltage adjustment module 14 will supply three-phase power (i.e. minimum power) to the used CPU 20.

In one exemplary embodiment, when a difference value between the maximum power output by the voltage adjustment module 14 and the working power of the used CPU 20 is greater than 5 W and less than 60 W, the second pin 2 of the first jumper block 12 is electrically coupled to the third pin 3 of the first jumper block 12 via the first jumper 18, and the second pin 2 of the second jumper block 12 is electrically coupled to the third pin 1 of the second jumper block 13 via the first jumper 19. In such a case, the second pin 2 of the first jumper block 12 is set at a low level voltage, and the second pin 2 of the second jumper block 13 is set at a high level voltage. When the voltage adjustment module 14 receives a low level voltage output by the second pin 2 of the first jumper block 12, and a low level voltage output by the second pin 2 of the second jumper block 12, the voltage adjustment module 14 will supply four-phase power to the used CPU 20.

The power supply circuit 100 can electrically connect different pins of the first jumper block 12 and the second jumper block 13 via the jumpers 18 and 19, such that signals received by the voltage adjustment module 14 can be changed when different CPU 20 is used. Accordingly, the phase power output by the voltage adjustment module 14 can be changed when different CPU 20 is used, and utilization ratio of the power can be improved.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A power supply circuit for a CPU, comprising:
a voltage adjustment module electrically coupled to the CPU;
a first jumper block, the first jumper block comprising a first pin electrically coupled to a power source, a second pin electrically coupled to the voltage adjustment module, and a third pin grounded;
a second jumper block, the second jumper block comprising a first pin electrically coupled to a power source, a second pin electrically coupled to the voltage adjustment module, and a third pin grounded;
a first jumper that electrically connects the first pin of the first jumper block to the second pin of the first jumper block or electrically connects the second pin of the first jumper block to the third pin of the first jumper block; and
a second jumper that electrically connects the first pin of the second jumper block to the second pin of the second jumper block or electrically connects the second pin of the second jumper block to the third pin of the second jumper block, the voltage adjustment module adjusting a phase number power supply to supply corresponding phase power to the CPU based on the signals output by the second pins of the first jumper block and the second jumper block.

2. The power supply circuit of claim 1, further comprising two pull up resistors electrically connecting the two first pins to the corresponding power sources, respectively.

3. The power supply circuit of claim 1, wherein the voltage adjustment module outputs a maximum power in response to the second pin of the first jumper block being electrically coupled to the first pin of the first jumper block via the first jumper and the second pin of the second jumper block being electrically coupled to the first pin of the second jumper block.

4. The power supply circuit of claim 3, wherein the voltage adjustment module outputs a minimum power in response to the second pin of the first jumper block being electrically coupled to the third pin of the first jumper block via the first jumper and the second pin of the second jumper block being electrically coupled to the third pin of the second jumper block, the voltage adjustment module outputs a minimum power.

5. The power supply circuit of claim 4, wherein the voltage adjustment module outputs a power between the minimum power and the maximum power in response to the second pin of the first jumper block being electrically coupled to the third pin of the first jumper block via the first jumper and the second pin of the second jumper block being electrically coupled to the first pin of the second jumper block.

6. The power supply circuit of claim 1, further comprising a socket connector electrically connecting the voltage adjustment module to the CPU.
